(19) United States
(12) Patent Application Publication
(10) Pub. No.: US 2026/0238248 A1
(43) Pub. Date: Aug. 13, 2026

(54) RADIO FREQUENCY MODULE AND COMMUNICATION DEVICE

(71) Applicant: Murata Manufacturing Co., Ltd., Nagaokakyo-shi (JP)

(72) Inventor: Takashi YAMADA, Nagaokakyo-shi (JP)

(73) Assignee: Murata Manufacturing Co., Ltd., Nagaokakyo-shi (JP)

(21) Appl. No.: 19/417,375

(22) Filed: Dec. 12, 2025

(30) Foreign Application Priority Data
Feb. 13, 2025 (JP) 2025-021400

(51) Int. Cl. H04B 1/40; H04B 1/00; H04L 5/14

(52) U.S. Cl. CPC H04B 1/40; H04B 1/0078; H04L 5/14

(57) ABSTRACT

A radio frequency module includes an antenna connection terminal, a first filter connected to the antenna connection terminal and has a pass band including the reception band of a band A, a second filter connected to the antenna connection terminal and has a pass band including the reception band of a band B for FDD, a low-noise amplifier circuit including input terminals, and a switch. An output terminal of the first filter is connected to a first input terminal of the low-noise amplifier via the switch, an output terminal of the second filter is connected to a second input terminal with no intervening switch, and the reception band of the band A and the transmission band of the band B at least partially overlap each other.

### CROSS-REFERENCE TO RELATED APPLICATION

The present application claims priority to Japanese patent application JP 2025-021400, filed Feb. 13, 2025, the entire contents of which being incorporated herein by reference.

### BACKGROUND

### 1. Field

The present disclosure relates to a radio frequency module and a communication device.

### 2. Description of the Related Art

With the advancement of multiband technologies for mobile communication devices, such as mobile phones, radio frequency modules capable of amplifying signals in multiple bands using a single low-noise amplifier circuit have been proposed. For example, Japanese Unexamined Patent Application Publication No. 2021-016049 discloses a radio frequency circuit with a configuration in which a reception filter for a frequency division duplex (FDD) band and a reception filter for another band are connected to a low-noise amplifier via a single-pole double-throw (SPDT) switch circuit.

### SUMMARY

However, with the related-art technology, when signals in the FDD band are transmitted and received simultaneously, the reception sensitivity of reception signals in the FDD band may be degraded.

For this reason, the present disclosure provides a radio frequency module and a communication device configured to suppress degradation of reception sensitivity.

According to an aspect of the present disclosure, a radio frequency module includes an antenna connection terminal; a first filter that is connected to the antenna connection terminal and has a pass band including the reception band of a first band; a second filter that is connected to the antenna connection terminal and has a pass band including the reception band of a second FDD band; a low-noise amplifier circuit including a first input terminal and a second input terminal; and a first switch. The output terminal of the first filter is connected to the first input terminal via the first switch; the output terminal of the second filter is connected to the second input terminal with no intervening switch; and the reception band of the first band and the transmission band of the second FDD band at least partially overlap each other.

According to an aspect of the present disclosure, a communication device includes a signal processing circuit configured to process radio frequency signals; the above-described radio frequency module configured to transfer the radio frequency signals between the signal processing circuit and a first antenna; and a transmission module configured to transfer the radio frequency signals between the signal processing circuit and a second antenna. The transmission module includes a power amplifier and a fourth filter that is connected between the second antenna and the output terminal of the power amplifier and has a pass band including the transmission band of the second FDD band.

The present disclosure makes it possible to provide a radio frequency module and a communication device configured to suppress degradation of reception sensitivity.

### BRIEF DESCRIPTION OF THE DRAWINGS

FIG. 1 is a circuit diagram of a communication device according to a first embodiment;

FIG. 2A is a diagram for describing a first mode of a radio frequency module according to the first embodiment;

FIG. 2B is a diagram for describing a second mode of the radio frequency module according to the first embodiment;

FIG. 3 is a circuit diagram of a first switch according to a variation;

FIG. 4 is a circuit diagram of a communication device according to a second embodiment;

FIG. 5A is a diagram for describing a third mode of a radio frequency module according to the second embodiment; and

FIG. 5B is a diagram for describing a fourth mode of the radio frequency module according to the second embodiment.

### DESCRIPTION OF EMBODIMENTS

Embodiments of the present disclosure are described in detail below with reference to the drawings. Each of the embodiments described below represents a general or specific example. Values, shapes, materials, components, and layouts and connection configurations of the components described in the embodiments below are just examples and are not intended to limit the present disclosure.

Each of the drawings is a schematic diagram in which components are emphasized or omitted and the ratios between the components are adjusted to facilitate the understanding of the present disclosure. That is, components in each of the drawings are not necessarily illustrated accurately; and the shapes, positional relationships, and ratios of the components may differ from the actual shapes, positional relationships, and ratios. The same reference number is assigned to substantially the same components in the drawings, and repeated descriptions of those components may be omitted or simplified.

In the descriptions below, “connected” indicates that circuit elements are electrically connected, which may be a direct connection with a connection terminal and/or a wire conductor or an indirect connection via another circuit element. For example, “C is connected between A and B” indicates that one end of C is connected to A, the other end of C is connected to B, and C is placed in series in a path between A and B. “Path between A and B” indicates a path formed by a conductor that electrically connects A to B.

“Pass band of a filter” indicates a portion of a frequency spectrum that is passed by the filter and is defined as a frequency band between two frequencies at which the power insertion loss is 3 dB greater than the minimum power insertion loss.

“Transmission band” refers to a frequency band used for transmission in a communication device, and “reception band” refers to a frequency band used for reception in a communication device. For example, in an FDD band, different frequency bands (an uplink band and a downlink band) are used as a transmission band and a reception band. Also, for example, in a time division duplex (TDD) band, the same frequency band is used as a transmission band and a reception band.

“Band combination usable for simultaneous communication” refers to a combination of multiple frequency bands that can be used simultaneously for transmission, reception, or transmission and reception and is defined in advance by, for example, standardizing bodies (e.g., the 3rd Generation Partnership Project (3GPP) (registered trademark) and the Institute of Electrical and Electronics Engineers (IEEE)). Examples of “simultaneous communication” include carrier aggregation (CA), E-UTRAN New Radio-Dual Connectivity (EN-DC), New Radio-Dual Connectivity“ (NR-DC), and ”New Radio E-UTRAN-Dual Connectivity (NE-DC).

“Terminal” indicates a point at which a conductor in an element ends. Here, when the impedance of a conductor between elements is sufficiently low, a terminal is interpreted not only as a single point but also as any point on the conductor between the elements or the entire conductor.

### Embodiments

### 1. Configuration of Communication Device 6 According to First Embodiment

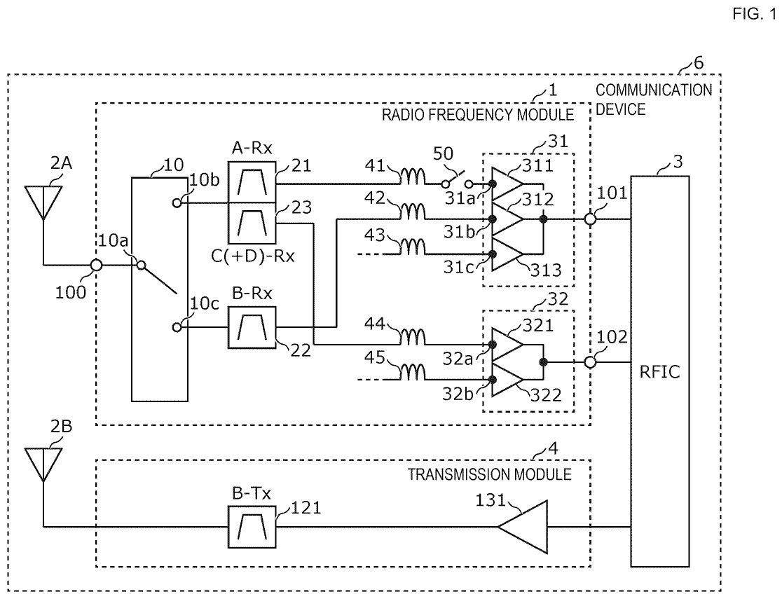

First, a configuration of a communication device 6 according to a first embodiment is described with reference to FIG. 1. FIG. 1 is a circuit diagram of the communication device 6 according to the first embodiment.

Here, FIG. 1 illustrates an exemplary configuration, and the communication device 6 may be implemented by using any of various types of circuit implementation and circuit technologies. Therefore, the descriptions of the communication device 6 provided below should not be interpreted restrictively.

The communication device 6 can be used to provide wireless connection. For example, the communication device 6 may be used for UEs, such as mobile phones, smartphones, tablet computers, and wearable devices, in a cellular network (also referred to as a mobile network). As another example, the communication device 6 may be used to provide wireless connection for Internet of Things (IoT) sensor devices, medical/healthcare devices, vehicles, unmanned aerial vehicles (UAV) (commonly known as drones), and automated guided vehicles (AGV). As still another example, the communication device 6 may be used to provide wireless connection at wireless access points or wireless hotspots.

The communication device 6 includes a radio frequency module 1, a transmission module 4, antennas 2A and 2B, and a radio frequency integrated circuit (RFIC) 3.

The radio frequency module 1 can transfer radio frequency signals between the antenna 2A and the RFIC 3. The transmission module 4 can transfer radio frequency signals between the antenna 2B and the RFIC 3. Detailed circuit configurations of the radio frequency module 1 and the transmission module 4 are described later.

The antenna 2A is connected to the radio frequency module 1, can receive radio frequency signals from outside the communication device 6, and can supply the received radio frequency signals to the radio frequency module 1. The antenna 2B is connected to the transmission module 4 and can transmit radio frequency signals received from the transmission module 4 outside the communication device 6. One or both of the antennas 2A and 2B do not have to be included in the communication device 6. Also, the communication device 6 may include one or more antennas in addition to the antennas 2A and 2B.

The RFIC 3 is an example of a signal processing circuit that processes radio frequency signals. Specifically, the RFIC 3 can perform signal processing, such as down-converting, on a radio frequency reception signal input via the radio frequency module 1 and output a reception signal generated by the signal processing to a BBIC. Also, the RFIC 3 can perform signal processing, such as up-converting, on a transmission signal input from a baseband integrated circuit (BBIC, not shown) and output a radio frequency transmission signal generated by the signal processing to the transmission module 4. Furthermore, the RFIC 3 may include a control unit that controls switches and amplifiers included in the radio frequency module 1 and the transmission module 4. Some or all of the functions of the control unit of the RFIC 3 may be provided outside the RFIC 3 and may be included in, for example, the BBIC or the radio frequency module 1.

### 2. Circuit Configuration of Radio Frequency Module 1 According to First Embodiment

As illustrated in FIG. 1, the radio frequency module 1 includes low-noise amplifier circuits 31 and 32, filters 21, 22, and 23, switches 10 and 50, inductors 41, 42, 43, 44, and 45, an antenna connection terminal 100, and radio frequency output terminals 101 and 102.

The antenna connection terminal 100 is an external connection terminal of the radio frequency module 1 and receives radio frequency signals from the antenna 2A. The antenna connection terminal 100 is connected to the antenna 2A outside the radio frequency module 1 and is connected to the switch 10 inside the radio frequency module 1.

The radio frequency output terminals 101 and 102 are external connection terminals of the radio frequency module 1 and supply radio frequency signals to the RFIC 3. The radio frequency output terminals 101 and 102 are connected to the RFIC 3 outside the radio frequency module 1 and are connected, respectively, to the low-noise amplifier circuits 31 and 32 inside the radio frequency module 1.

The low-noise amplifier circuit 31 includes input terminals 31a, 31b, and 31c, a first output terminal, and amplifier transistors 311, 312, and 313. The amplifier transistor 311 is an example of a first amplifier transistor, and the amplifier transistor 312 is an example of a second amplifier transistor. The input terminal 31a is an example of a first input terminal, and the input terminal 31b is an example of a second input terminal.

The amplifier transistor 311 is connected between the input terminal 31a and the first output terminal. The amplifier transistor 312 is connected between the input terminal 31b and the first output terminal. The amplifier transistor 313 is connected between the input terminal 31c and the first output terminal. The input terminal 31a is connected to the output terminal of the filter 21 via a switched path that includes the switch 50 and the inductor 41. The input terminal 31b is connected to the output terminal of the filter 22 via a non-switched path that includes the inductor 42 but has no intervening switch. The input terminal 31c is connected to the output terminal of a filter (not shown) via the inductor 43 with no intervening switch. The first output terminal is connected to the radio frequency output terminal 101.

The low-noise amplifier circuit 32 includes input terminals 32a and 32b, a second output terminal, and amplifier transistors 321 and 322. The amplifier transistor 321 is connected between the input terminal 32a and the second output terminal. The amplifier transistor 322 is connected between the input terminal 32b and the second output terminal. The input terminal 32a is connected to the output terminal of the filter 23 via the inductor 44 with no intervening switch. The input terminal 32b is connected to the output terminal of a filter (not shown) via the inductor 45 with no intervening switch. The second output terminal is connected to the radio frequency output terminal 102.

Each of the amplifier transistors 311-313, 321, and 322 is, for example, a bipolar transistor that includes a base terminal (input terminal), a collector terminal (output terminal), and an emitter terminal (ground terminal). Alternatively, each of the amplifier transistors 311-313, 321, and 322 may be, for example, a field-effect transistor (FET) that includes a gate terminal (input terminal), a drain terminal (output terminal), and a source terminal (ground terminal).

Furthermore, an additional amplifier transistor may be connected between the output terminal of each of the amplifier transistors 311 to 313 and the radio frequency output terminal 101.

The filter 21 is an example of a first filter and is a band pass filter that has a pass band including the reception band (A-Rx) of a band A. The filter 21 can pass signals in the reception band of the band A and can attenuate signals outside the reception band of the band A. A first end of the filter 21 is connected to the antenna connection terminal 100 via the switch 10, and a second end of the filter 21 is connected to the input terminal 31a via the inductor 41 and the switch 50.

The filter 22 is an example of a second filter and is a band pass filter that has a pass band including the reception band (B-Rx) of a band B. The filter 22 can pass signals in the reception band of the band B and can attenuate signals outside the reception band of the band B. A first end of the filter 22 is connected to the antenna connection terminal 100 via the switch 10, and a second end of the filter 22 is connected to the input terminal 31b via the inductor 42.

The filter 23 is an example of a third filter and is a band pass filter that has a pass band including the reception band (C-Rx) of a band C. The filter 23 can pass signals in the reception band of the band C and can attenuate signals outside the reception band of the band C. A first end of the filter 23 is connected to the antenna connection terminal 100 via the switch 10, and a second end of the filter 23 is connected to the input terminal 32a via the inductor 44. The pass band of the filter 23 may include the reception band of the band C and the reception band of a band D (C (+D)−Rx). The reception band of the band C and the reception band of the band D at least partially overlap each other.

Each of the filters 21 to 23 is not limited to a band pass filter. Some or all of the filters 21 to 23 may be band elimination filters, high pass filters, low pass filters, or any combination of these filters.

The switch 50 is an example of a first switch and is a single-pole single-throw (SPST) switch. The switch 50 is connected between the filter 21 and the input terminal 31a. Specifically, a first end of the switch 50 is connected to the output terminal of the filter 21 via the inductor 41, and a second end of the switch 50 is connected to the input terminal 31a of the low-noise amplifier circuit 31. The switch 50 toggles the connection and disconnection between the filter 21 and the low-noise amplifier circuit 31 based on, for example, a control signal supplied from the RFIC 3.

The switch 10 is an example of a second switch and is an SPDT switch including a common terminal 10a and selection terminals 10b and 10c. The common terminal 10a is connected to the antenna connection terminal 100. The selection terminal 10b is an example of a first selection terminal and is connected to the input terminal of the filter 21 and the input terminal of the filter 23. The selection terminal 10c is an example of a second selection terminal and is connected to the input terminal of the filter 22.

The inductor 41 is an example of a first inductor and is connected between the output terminal of the filter 21 and the input terminal 31a. The inductor 41 is an element for achieving impedance matching between the filter 21 and the low-noise amplifier circuit 31.

The inductor 42 is an example of a second inductor and is connected between the output terminal of the filter 22 and the input terminal 31b. The inductor 42 is an element for achieving impedance matching between the filter 22 and the low-noise amplifier circuit 31.

The inductor 43 is an element that is connected to the input terminal 31c and is provided to achieve impedance matching between a filter (not shown) and the low-noise amplifier circuit 31. The inductor 44 is an element that is connected between the output terminal of the filter 23 and the input terminal 32a and is provided to achieve impedance matching between the filter 23 and the low-noise amplifier circuit 32. The inductor 45 is an element that is connected to the input terminal 32b and is provided to achieve impedance matching between a filter (not shown) and the low-noise amplifier circuit 32.

At least one of the inductors 41 to 45 does not have to be included in the radio frequency module 1. Also, capacitors may be connected in place of the inductors 41 to 45, and inductors or capacitors may be connected between the input terminals of the low-noise amplifier circuits 31 and 32 and the ground in place of the inductors 41 to 45.

### 3. Frequency Bands Used by Radio Frequency Module 1

The bands A, B, and C supported by the radio frequency module 1 are described.

The bands A, B, and C are frequency bands used for communication systems constructed using radio access technologies (RAT). The bands A, B, and C are predefined by standardizing bodies (e.g., 3GPP (registered trademark) and IEEE). Examples of communication systems include 5th Generation New Radio (5G NR) systems, 4th Generation Long Term Evolution (4G LTE) systems, Second Generation Global System for Mobile Communications (2G GSM) systems, and Wireless Local Area Network (WLAN) systems.

The band A is an example of a first band, which is an FDD band, a TDD band, or a supplementary uplink (SUL) band. LTE Band 3 or 40a or 5G NR n3 or n 40a may be used as the band A. However, the band A is not limited to these bands.

The band B is an example of a second FDD band. LTE Band 25 or 30 or 5G NR n25 or n30 may be used as the band B. However, the band B is not limited to these bands.

The band C is an example of a third band, which is an FDD band, a TDD band, or an SDL band. LTE Band 1 or 5G NR n1 may be used as the band C. However, the band C is not limited to these bands.

The band D is an example of a fourth band, which is an FDD band, a TDD band, or an SDL band. LTE Band 66 or 5G NR n66 may be used as the band D. However, the band D is not limited to these bands.

The bands B and C are a band combination usable for simultaneous communication. Specifically, the transmission and reception of signals in the band B and the reception of signals in the band C can be performed simultaneously. The bands A and C are a band combination usable for simultaneous communication. Specifically, the reception of signals in the band A and the reception of signals in the band C can be performed simultaneously. The reception band of the band A at least partially overlaps the transmission band of the band B.

For example, when the band B is Band 25 or n25, Band 3 or n3 can be used as the band A, Band 1 or n1 can be used as the band C, and Band 66 or n66 can be used as the band D.

Also, for example, when the band B is Band 30 or n30, Band 40a or n40a can be used as the band A, Band 1 or n1 can be used as the band C, and Band 66 or n66 can be used as the band D.

### 4. Circuit Configuration of Transmission Module 4 according to First Embodiment

As illustrated in FIG. 1, the transmission module 4 includes a power amplifier 131 and a filter 121.

The input terminal of the power amplifier 131 is connected to the RFIC 3, and the output terminal of the power amplifier 131 is connected to the input terminal of the filter 121.

The filter 121 is an example of a fourth filter and is a band pass filter that has a pass band including the transmission band (B-Tx) of the band B. The filter 121 can pass signals in the transmission band of the band B and can attenuate signals outside the transmission band of the band B. A first end of the filter 121 is connected to the power amplifier 131, and a second end of the filter 121 is connected to the antenna 2B.

The transmission module 4 may be included in the radio frequency module 1.

### 5. Communication Modes of Radio Frequency Module 1

Next, communication modes of the radio frequency module 1 according to the first embodiment are described.

### 5.1. First Mode

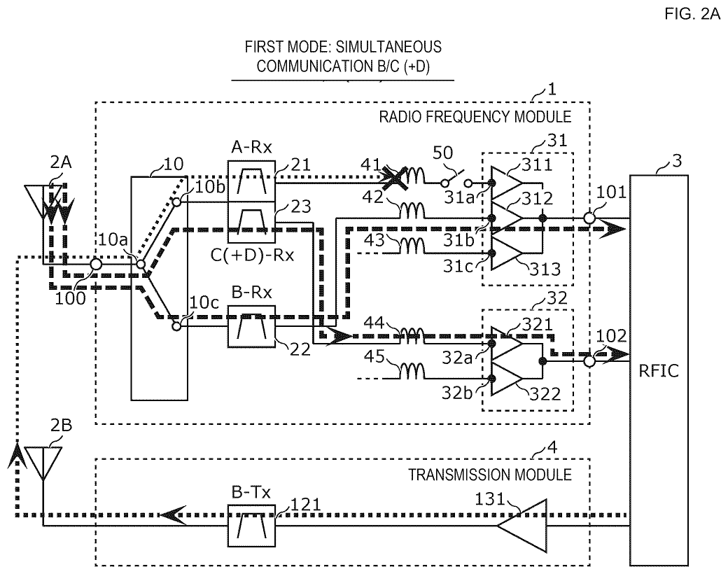

A first mode of the radio frequency module 1 is described with reference to FIG. 2A. FIG. 2A is a diagram for describing the first mode of the radio frequency module 1 according to the first embodiment. In FIG. 2A, dashed arrows represent signal paths.

The first mode is a communication mode for simultaneously performing the transmission and reception of signals in the band B and the reception of signals in the band C. The first mode also includes a case in which the transmission and reception of signals in the band B and the reception of signals in the band D are performed simultaneously. In the first mode of the radio frequency module 1, the common terminal 10a is connected to the selection terminal 10b, the common terminal 10a is connected to the selection terminal 10c, and the switch 50 is opened.

In this state, a reception signal in the band B is transferred from the antenna 2A to the RFIC 3 via the antenna connection terminal 100, the switch 10, the filter 22, the inductor 42, the low-noise amplifier circuit 31, and the radio frequency output terminal 101. A reception signal in the band C is transferred from the antenna 2A to the RFIC 3 via the antenna connection terminal 100, the switch 10, the filter 23, the inductor 44, the low-noise amplifier circuit 32, and the radio frequency output terminal 102.

Also, in the first mode, a transmission signal in the band B supplied from the RFIC 3 is output from the antenna 2B via the power amplifier 131 and the filter 121.

Here, the transmission signal in the band B output from the antenna 2B may enter the antenna 2A. Because the transmission band of the band B at least partially overlaps the reception band of the band A, the transmission signal in the band B entering the antenna 2A can pass through the filter 21.

If the switch 50 is not provided and the inductor 41 is directly connected to the input terminal 31a, the transmission signal in the band B entering the antenna 2A passes through the filter 21 and flows into the low-noise amplifier circuit 31 via the input terminal 31a, such that an interference path is created. The transmission signal in the band B flowing into the low-noise amplifier circuit 31 interferes with the reception signal in the band B input to the low-noise amplifier circuit 31 via the filter 22 and the input terminal 31b. In other words, an undesired transmission signal in the band B, having entered antenna 2A and passed through filter 21 due to the frequency overlap 35, would flow into the input terminal 31a. This unwanted signal at input 31a would then interfere within the low-noise amplifier circuit 31 with the desired reception signal in band B being simultaneously received at input 31b. This internal interference distorts the amplification characteristics of the LNA 31. As a result, the amplification characteristics of the low-noise amplifier circuit 31 are distorted, and the reception sensitivity of the low-noise amplifier circuit 31 for the reception signal in the band B is degraded.

In contrast, in the radio frequency module 1 according to the first embodiment, because the switch 50 is opened in the first mode, the transmission signal in the band B entering the antenna 2A does not reach the input terminal 31a. This in turn makes it possible to suppress the interference between the reception signal in the band B input to the low-noise amplifier circuit 31 and the transmission signal in the band B, suppress the distortion of the amplification characteristics of the low-noise amplifier circuit 31, and thereby suppress the degradation of the reception sensitivity of the low-noise amplifier circuit 31 for the reception signal in the band B.

Also, in the radio frequency module 1 according to the first embodiment, no switch is provided in series in the path connecting the filter 22 to the input terminal 31b. This makes it possible to reduce the size of the radio frequency module 1. This also makes it possible to reduce the transmission loss, resulting from the on-resistance of a switch, of the reception signal in the band B input to the low-noise amplifier circuit 31 via the filter 22 and the input terminal 31b. The reduction in the transmission loss can also reduce the degradation of the reception sensitivity of the low-noise amplifier circuit 31 for the reception signal in the band B.

### 5.2. Second Mode

A second mode of the radio frequency module 1 is described with reference to FIG. 2B. FIG. 2B is a diagram for describing the second mode of the radio frequency module 1 according to the first embodiment. In FIG. 2B, dashed arrows represent signal paths.

The second mode is a communication mode for simultaneously performing the reception of signals in the band A and the reception of signals in the band C. The second mode includes a case in which the reception of signals in the band A and the reception of signals in the band D are performed simultaneously. In the second mode of the radio frequency module 1, the common terminal 10a is connected to the selection terminal 10b, the common terminal 10a is disconnected from the selection terminal 10c, and the switch 50 is closed.

In this state, a reception signal in the band A is transferred from the antenna 2A to the RFIC 3 via the antenna connection terminal 100, the switch 10, the filter 21, the inductor 41, the switch 50, the low-noise amplifier circuit 31, and the radio frequency output terminal 101. A reception signal in the band C is transferred from the antenna 2A to the RFIC 3 via the antenna connection terminal 100, the switch 10, the filter 23, the inductor 44, the low-noise amplifier circuit 32, and the radio frequency output terminal 102.

Thus, in the second mode, the reception signal in the band A and the reception signal in the band C can be transferred while achieving isolation.

### 6. Configuration of First Switch according to Variation

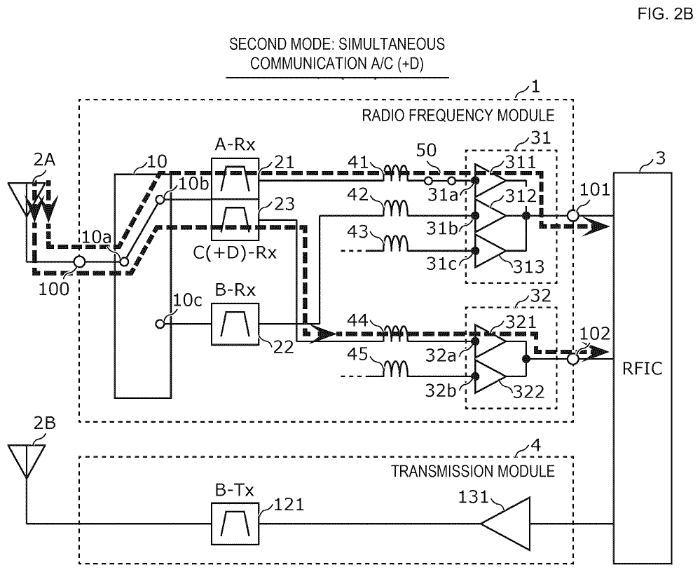

FIG. 3 is a circuit diagram of a switch 50A according to a variation. In the radio frequency module 1 according to the first embodiment, the switch 50 may be implemented by the switch 50A illustrated in FIG. 3.

As illustrated in FIG. 3, the switch 50A includes switch elements 501, 502, and 503. The switch element 501 is an example of a first switch element, and the switch element 502 is an example of a second switch element. The switch elements 501 and 502 are connected in series with each other and are arranged in series between the output terminal of the filter 21 and the input terminal 31a. The switch element 503 is an example of a third switch element and is connected between the ground and the connection point between the switch elements 501 and 502. Each of the switch elements 501 to 503 is implemented by, for example, one or more series-connected FETs.

In the present variation, in the first mode, the common terminal 10a is connected to the selection terminal 10b, the common terminal 10a is connected to the selection terminal 10c, the switch elements 501 and 502 are opened, and the switch element 503 is closed. In the second mode, the common terminal 10a is connected to the selection terminal 10b, the common terminal 10a is disconnected from the selection terminal 10c, the switch elements 501 and 502 are closed, and the switch element 503 is opened.

This configuration makes it possible to improve the isolation between the combination of the filter 21 and the inductor 41 and the low-noise amplifier circuit 31 when the switch 50A is opened.

### 7. Effects of First Embodiment

As described above, the radio frequency module 1 according to the first embodiment includes the antenna connection terminal 100; the filter 21 that is connected to the antenna connection terminal 100 and has a pass band including the reception band of the band A; the filter 22 that is connected to the antenna connection terminal 100 and has a pass band including the reception band of the band B for FDD; the low-noise amplifier circuit 31 including the input terminals 31a and 31b; and the switch 50. The output terminal of the filter 21 is connected to the input terminal 31a via the switch 50, and the output terminal of the filter 22 is connected to the input terminal 31b with no intervening switch. The reception band of the band A and the transmission band of the band B at least partially overlap each other.

With this configuration, when signals in the band B are transmitted and received, a transmission signal in the band B entering the antenna 2A is prevented from reaching the low-noise amplifier circuit 31 by opening the switch 50. This makes it possible to suppress the interference between a reception signal in the band B and a transmission signal in the band B and thereby makes it possible to suppress the degradation of the reception sensitivity of the low-noise amplifier circuit 31 for the reception signal in the band B. Also, because no switch is provided in series in the path connecting the filter 22 to the input terminal 31b, the transmission loss of the reception signal in the band B can be reduced. Accordingly, it is possible to suppress the degradation of the reception sensitivity while reducing the size of the radio frequency module 1.

For example, the radio frequency module 1 also includes the filter 23 that has a pass band including the reception band of the band C, and the switch 10 that includes the common terminal 10a connected to the antenna connection terminal 100, the selection terminal 10b connected to the input terminal of the filter 21 and the input terminal of the filter 23, and the selection terminal 10c connected to the input terminal of the filter 22. The filters 21, 22, and 23 are connected to the antenna connection terminal 100 via the switch 10.

For example, in the radio frequency module 1, the bands A and C are a band combination usable for simultaneous communication, and the bands B and C are a band combination usable for simultaneous communication. In the first mode for simultaneously performing the transmission and reception of signals in the band B and the reception of signals in the band C, the common terminal 10a is connected to the selection terminal 10b, the common terminal 10a is connected to the selection terminal 10c, and the switch 50 is opened. In the second mode for simultaneously performing the reception of signals in the band A and the reception of signals in the band C, the common terminal 10a is connected to the selection terminal 10b, and the switch 50 is closed.

With this configuration, in the first mode, the transmission signal in the band B entering the antenna 2A is prevented from reaching the low-noise amplifier circuit 31 by opening the switch 50. This makes it possible to suppress the interference between the reception signal in the band B and the transmission signal in the band B and thereby makes it possible to suppress the degradation of the reception sensitivity of the low-noise amplifier circuit 31 for the reception signal in the band B. Also, because no switch is provided in series in the path connecting the filter 22 to the input terminal 31b, the transmission loss of the reception signal in the band B can be reduced. Accordingly, it is possible to suppress the degradation of the reception sensitivity while reducing the size of the radio frequency module 1.

Also, for example, in the radio frequency module 1, the filter 23 has a pass band including the reception band of the band C and the reception band of the band D, the reception band of the band C and the reception band of the band D at least partially overlap each other, the bands A and C are a band combination usable for simultaneous communication, and the band B for FDD and the band D are a band combination usable for simultaneous communication. In the first mode for simultaneously performing the transmission and reception of signals in the band B and the transmission and reception of signals in the band D, the common terminal 10a is connected to the selection terminal 10b, the common terminal 10a is connected to the selection terminal 10c, and the switch 50 is opened. In the second mode for simultaneously performing the transmission and reception of signals in the band A and the transmission and reception of signals in the band C, the common terminal 10a is connected to the selection terminal 10b, and the switch 50 is closed.

With this configuration, in the first mode, the transmission signal in the band B entering the antenna 2A is prevented from reaching the low-noise amplifier circuit 31 by opening the switch 50. This makes it possible to suppress the interference between the reception signal in the band B and the transmission signal in the band B and thereby makes it possible to suppress the degradation of the reception sensitivity of the low-noise amplifier circuit 31 for the reception signal in the band B. Also, because no switch is provided in series in the path connecting the filter 22 to the input terminal 31b, the transmission loss of the reception signal in the band B can be reduced. Accordingly, it is possible to suppress the degradation of the reception sensitivity while reducing the size of the radio frequency module 1.

Also, for example, in the radio frequency module 1, the band A is LTE Band 3 or 5G NR n3, the band B is LTE Band 25 or 5G NR n25, the band C is LTE Band 1 or 5G NR n1, and the band D is LTE Band 66 or 5G NR n66.

This makes it possible to use the radio frequency module 1 for LTE systems and/or 5G NR systems.

Also, for example, in the radio frequency module 1, the band A is LTE Band 40a or 5G NR n40a, the band B is LTE Band 30 or 5G NR n30, the band C is LTE Band 1 or 5G NR n1, and the band D is LTE Band 66 or 5G NR n66.

This makes it possible to use the radio frequency module 1 for LTE systems and/or 5G NR systems.

Also, for example, in the radio frequency module 1, the low-noise amplifier circuit 31 further includes the first output terminal, the amplifier transistor 311 connected between the input terminal 31a and the first output terminal, and the amplifier transistor 312 connected between the input terminal 31b and the first output terminal.

This configuration makes it possible to optimize the amplification characteristics according to the band of a signal to be amplified.

Alos, for example, the radio frequency module 1 further includes the inductor 41 connected between the output terminal of the filter 21 and the input terminal 31a and the inductor 42 connected between the output terminal of the filter 22 and the input terminal 31b.

This makes it possible to achieve impedance matching between the filters 21 and 22 and the low-noise amplifier circuit 31.

Also, for example, in the radio frequency module 1, the switch 50A includes the switch elements 501 and 502 that are connected in series with each other and are arranged in series between the output terminal of the filter 21 and the input terminal 31a, and the switch element 503 connected between the ground and the connection point between the switch elements 501 and 502.

This configuration makes it possible to improve the isolation between the filter 21 and the low-noise amplifier circuit 31 when the switch 50A is opened.

Also, the communication device 6 according to the first embodiment includes the RFIC 3 configured to process radio frequency signals, the radio frequency module 1 configured to transfer radio frequency signals between the RFIC 3 and the antenna 2A, and the transmission module 4 configured to transfer radio frequency signals between the RFIC 3 and the antenna 2B. The transmission module 4 includes the power amplifier 131 and the filter 121 that is connected between the antenna 2B and the output terminal of the power amplifier 131 and has a pass band including the transmission band of the band B.

With this configuration, the communication device 6 can achieve effects that are substantially the same as those achieved by the radio frequency module 1.

### 8. Configuration of Communication Device 7 according to Second Embodiment

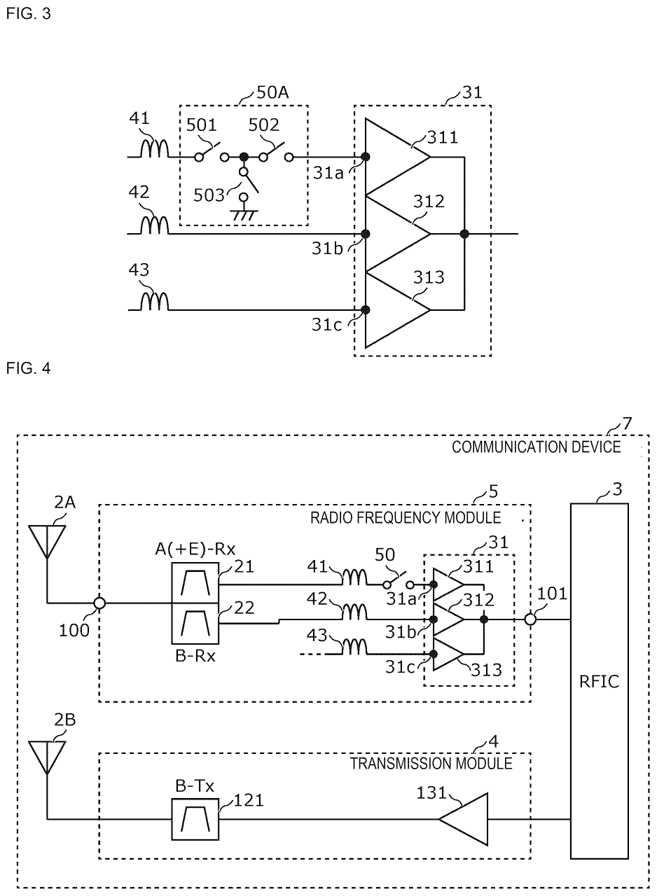

Next, a configuration of a communication device 7 according to a second embodiment is described with reference to FIG. 4. FIG. 4 is a circuit diagram of the communication device 7 according to the second embodiment.

The communication device 7 includes a radio frequency module 5, a transmission module 4, antennas 2A and 2B, and an RFIC 3. The communication device 7 of the present embodiment differs from the communication device 6 of the first embodiment only in the configuration of the radio frequency module 5. Below, descriptions of components of the communication device 7 of the present embodiment corresponding to the components of the communication device 6 of the first embodiment are omitted, and differences from the communication device 6 are mainly described.

### 9. Circuit Configuration of Radio Frequency Module 5 according to Second Embodiment

As illustrated in FIG. 4, the radio frequency module 5 includes a low-noise amplifier circuit 31, filters 21 and 22, a switch 50, inductors 41, 42, and 43, an antenna connection terminal 100, and a radio frequency output terminal 101.

The antenna connection terminal 100 is an external connection terminal of the radio frequency module 5 and receives radio frequency signals from the antenna 2A. The antenna connection terminal 100 is connected to the antenna 2A outside the radio frequency module 5 and is connected to the filters 21 and 22 inside the radio frequency module 5.

The radio frequency output terminal 101 is an external connection terminal of the radio frequency module 5 and supplies radio frequency signals to the RFIC 3. The radio frequency output terminal 101 is connected to the RFIC 3 outside the radio frequency module 5 and connected to the low-noise amplifier circuit 31 inside the radio frequency module 5.

The low-noise amplifier circuit 31 includes input terminals 31a, 31b, and 31c, a first output terminal, and amplifier transistors 311, 312, and 313. The amplifier transistor 311 is an example of a first amplifier transistor, and the amplifier transistor 312 is an example of a second amplifier transistor. The input terminal 31a is an example of a first input terminal, and the input terminal 31b is an example of a second input terminal.

The amplifier transistor 311 is connected between the input terminal 31a and the first output terminal. The amplifier transistor 312 is connected between the input terminal 31b and the first output terminal. The amplifier transistor 313 is connected between the input terminal 31c and the first output terminal. The input terminal 31a is connected to the output terminal of the filter 21 via the switch 50 and the inductor 41. The input terminal 31b is connected to the output terminal of the filter 22 via the inductor 42 with no intervening switch. The input terminal 31c is connected to the output terminal of a filter (not shown) via the inductor 43 with no intervening switch. The first output terminal is connected to the radio frequency output terminal 101.

Furthermore, an additional amplifier transistor may be connected between the output terminal of each of the amplifier transistors 311 to 313 and the radio frequency output terminal 101.

The filter 21 is an example of a first filter and is a band pass filter that has a pass band including a reception band (A-Rx) of the band A. A first end of the filter 21 is connected to the antenna connection terminal 100, and a second end of the filter 21 is connected to the input terminal 31a via the inductor 41 and the switch 50. The pass band of the filter 21 may include the reception band of the band A and the reception band of the band E (A(+E)−Rx). The reception band of the band A at least partially overlaps the reception band of the band E.

The filter 22 is an example of a second filter and is a band pass filter that has a pass band including the reception band (B-Rx) of the band B. A first end of the filter 22 is connected to the antenna connection terminal 100, and a second end of the filter 22 is connected to the input terminal 31b via the inductor 42.

The filters 21 and 22 are not limited to band pass filters. Either or both of the filters 21 and 22 may be band elimination filters, high pass filters, low pass filters, or any combination of these filters.

The switch 50 is an example of a first switch and is an SPST switch. The switch 50 is connected between the filter 21 and the input terminal 31a. Specifically, a first end of the switch 50 is connected to the output terminal of the filter 21 via the inductor 41, and a second end of the switch 50 is connected to the input terminal 31a of the low-noise amplifier circuit 31. The switch 50 toggles the connection and disconnection between the filter 21 and the low-noise amplifier circuit 31 based on, for example, a control signal supplied from the RFIC 3.

The inductor 41 is an example of a first inductor and is connected between the output terminal of the filter 21 and the input terminal 31a. The inductor 42 is an example of a second inductor and is connected between the output terminal of the filter 22 and the input terminal 31b. The inductor 43 is connected to the input terminal 31c.

At least one of the inductors 41 to 43 does not have to be included in the radio frequency module 5. Also, capacitors may be connected in place of the inductors 41 to 43, and inductors or capacitors may be connected between the input terminals of the low-noise amplifier circuit 31 and the ground in place of the inductors 41 to 43.

In the radio frequency module 5, the switch 50 may be implemented by the switch 50A illustrated in FIG. 3. This configuration makes it possible to improve the isolation between the combination of the filter 21 and the inductor 41 and the low-noise amplifier circuit 31 when the switch 50A is opened.

### 10. Frequency Bands Used by Radio Frequency Module 5

Bands A and B supported by the radio frequency module 5 are described.

The bands A and B are frequency bands used for communication systems constructed using radio access technologies (RAT). The bands A and B are predefined by standardizing bodies (e.g., 3GPP (registered trademark) and IEEE). Examples of communication systems include a 5G NR system, a 4G LTE system, a 2G GSM system, and a WLAN system.

The band A is an example of a first band and is an FDD band, a TDD band, or an SUL band. LTE Band 20 or Band 26 or 5G NR n20 or n26 may be used as the band A. However, the band A is not limited to these bands.

The band B is an example of a second FDD band. LTE Band 5 or Band 8 or 5G NR n5 or n8 may be used as the band B. However, the band B is not limited to these bands.

The band E is an example of a fifth band and is an FDD band, a TDD band, or an SDL band. LTE Band 28 or Band 5 or 5G NR n28 or n5 may be used as the band E. However, the band E is not limited to these bands.

The bands A and E are a band combination usable for simultaneous communication. Specifically, the transmission and reception of signals in the band A and the transmission and reception of signals in the band E can be performed simultaneously. Also, the reception band of the band A and the transmission band of the band E at least partially overlap each other.

For example, when the band B is Band 5 or n5, Band 20 or n20 can be used as the band A, and Band 28 or n28 can be used as the band E.

Also, for example, when the band B is Band 8 or n8, Band 26 or n26 can be used as the band A, and Band 5 or n5 can be used as the band E.

### 11. Communication Modes of Radio Frequency Module 5

Next, communication modes of the radio frequency module 5 according to the second embodiment are described.

### 11.1. Third Mode

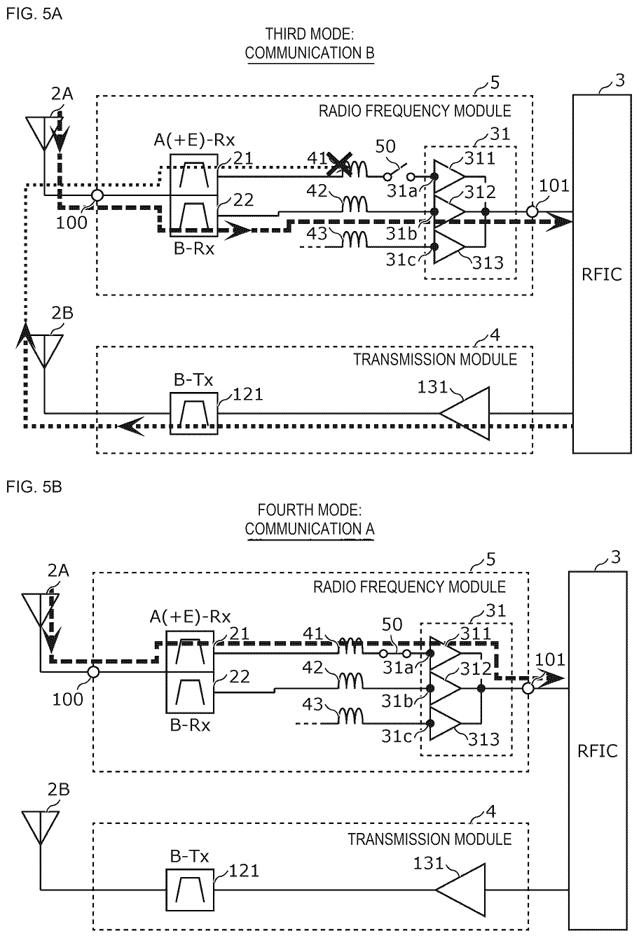

A third mode of the radio frequency module 5 is described with reference to FIG. 5A. FIG. 5A is a diagram for describing the third mode of the radio frequency module 5 according to the second embodiment. In FIG. 5A, dashed arrows represent signal paths.

The third mode is a communication mode for transmitting and receiving signals in the band B. In the third mode of the radio frequency module 5, the switch 50 is opened.

In this state, a reception signal in the band B is transferred from the antenna 2A to the RFIC 3 via the antenna connection terminal 100, the filter 22, the inductor 42, the low-noise amplifier circuit 31, and the radio frequency output terminal 101.

Also, in the third mode, a transmission signal in the band B supplied from the RFIC 3 is output from the antenna 2B via the power amplifier 131 and the filter 121.

Here, the transmission signal in the band B output from the antenna 2B may enter the antenna 2A. Because the transmission band of the band B at least partially overlaps the reception band of the band A, the transmission signal in the band B entering the antenna 2A can pass through the filter 21.

Here, if the switch 50 is not provided and the inductor 41 is directly connected to the input terminal 31a, the transmission signal in the band B entering the antenna 2A passes through the filter 21 and flows into the low-noise amplifier circuit 31 via the input terminal 31a. The transmission signal in the band B flowing into the low-noise amplifier circuit 31 interferes with the reception signal in the band B input to the low-noise amplifier circuit 31 via the filter 22 and the input terminal 31b. As a result, the amplification characteristics of the low-noise amplifier circuit 31 are distorted, and the reception sensitivity of the low-noise amplifier circuit 31 for the reception signal in the band B is degraded.

In contrast, in the radio frequency module 5 according to the second embodiment, because the switch 50 is opened in the third mode, the transmission signal in the band B entering the antenna 2A does not reach the input terminal 31a. This makes it possible to suppress the interference between the reception signal in the band B input to the low-noise amplifier circuit 31 and the transmission signal in the band B, suppress the distortion of the amplification characteristics of the low-noise amplifier circuit 31, and thereby suppress the degradation of the reception sensitivity of the low-noise amplifier circuit 31 for the reception signal in the band B.

Also, in the radio frequency module 5 according to the second embodiment, no switch is provided in series in the path connecting the filter 22 to the input terminal 31b. This makes it possible to reduce the size of the radio frequency module 5. This also makes it possible to reduce the transmission loss, resulting from the on-resistance of a switch, of the reception signal in the band B input to the low-noise amplifier circuit 31 via the filter 22 and the input terminal 31b. The reduction in the transmission loss can also reduce the degradation in the reception sensitivity of the low-noise amplifier circuit 31 for the reception signal in the band B.

### 11.2 Fourth Mode and Fifth Mode

A fourth mode of the radio frequency module 5 is described with reference to FIG. 5B. FIG. 5B is a diagram for describing the fourth mode of the radio frequency module 5 according to the second embodiment. In FIG. 5B, a dashed arrow represents a signal path.

The fourth mode is a communication mode for receiving signals in the band A. In the fourth mode of the radio frequency module 5, the switch 50 is closed.

In this state, a reception signal in the band A (and a reception signal in the band E) is transferred from the antenna 2A to the RFIC 3 via the antenna connection terminal 100, the filter 21, the inductor 41, the switch 50, the low-noise amplifier circuit 31, and the radio frequency output terminal 101.

Thus, in the fourth mode, reception signals in the band A can be transferred.

A fifth mode is a communication mode for simultaneously performing the reception of signals in the band A and the reception of signals in the band E. In the fifth mode of the radio frequency module 5, the switch 50 is closed.

In this state, a reception signal in the band A and a reception signal in the band E are transferred from the antenna 2A to the RFIC 3 via the antenna connection terminal 100, the filter 21, the inductor 41, the switch 50, the low-noise amplifier circuit 31, and the radio frequency output terminal 101.

Thus, in the fifth mode, reception signals in the band A and reception signals in the band E can be transferred.

### 12. Effects of Second Embodiment

As described above, the radio frequency module 5 according to the second embodiment includes the antenna connection terminal 100, the filter 21 that is connected to the antenna connection terminal 100 and has a pass band including the reception band of the band A, the filter 22 that is connected to the antenna connection terminal 100 and has a pass band including the reception band of the band B for FDD, the low-noise amplifier circuit 31 including the input terminals 31a and 31b, and the switch 50. The output terminal of the filter 21 is connected to the input terminal 31a via the switch 50, the output terminal of the filter 22 is connected to the input terminal 31b with no intervening switch, and the reception band of the band A and the transmission band of the band B at least partially overlap each other.

With this configuration, when signals in the band B are transmitted and received, a transmission signal in the band B entering the antenna 2A is prevented from reaching the low-noise amplifier circuit 31 by opening the switch 50. This makes it possible to suppress the interference between the reception signal in the band B and the transmission signal in the band B and thereby makes it possible to suppress the degradation of the reception sensitivity of the low-noise amplifier circuit 31 for the reception signal in the band B. Also, because no switch is provided in series in the path connecting the filter 22 to the input terminal 31b, the transmission loss of the reception signal in the band B can be reduced. Accordingly, it is possible to suppress the degradation of the reception sensitivity while reducing the size of the radio frequency module 5.

Also, for example, in the radio frequency module 5, the switch 50 is opened in the third mode for transmitting and receiving signals in the band B, and the switch 50 is closed in the fourth mode for receiving signals in the band A.

With this configuration, in the third mode, the transmission signal in the band B entering the antenna 2A is prevented from reaching the low-noise amplifier circuit 31 by opening the switch 50. This makes it possible to suppress the interference between the reception signal in the band B and the transmission signal in the band B and thereby makes it possible to suppress the degradation of the reception sensitivity of the low-noise amplifier circuit 31 for the reception signal in the band B. Also, because no switch is provided in series in the path connecting the filter 22 to the input terminal 31b, the transmission loss of the reception signal in the band B can be reduced. Accordingly, it is possible to suppress the degradation of the reception sensitivity while reducing the size of the radio frequency module 5.

Also, for example, in the radio frequency module 5, the band A is LTE Band 26 or 5G NR n26, and the band B is LTE Band 8 or 5G NR n8.

This makes it possible to use the radio frequency module 5 for LTE systems and/or 5G NR systems.

Also, for example, in the radio frequency module 5, the filter 21 has a pass band including the reception band of the band A and the reception band of the band E, the reception band of the band A and the reception band of the band E at least partially overlap each other, the band A and the band E are a band combination usable for simultaneous communication, the switch 50 is opened in the third mode for transmitting and receiving signals in the band B, and the switch 50 is closed in the fifth mode for simultaneously performing the reception of signals in the band A and the reception of signals in the band E.

Also, for example, in the radio frequency module 5, the band A is LTE Band 20 or 5G NR n20, the band B is LTE Band 5 or 5G NR n5, and the band E is LTE Band 28 or 5G NR n28.

This makes it possible to use the radio frequency module 5 for LTE systems and/or 5G NR systems.

The communication device 7 according to the second embodiment includes the RFIC 3 configured to process radio frequency signals, the radio frequency module 5 configured to transfer radio frequency signals between the RFIC 3 and the antenna 2A, and the transmission module 4 configured to transfer radio frequency signals between the RFIC 3 and the antenna 2A. The transmission module 4 includes the power amplifier 131 and the filter 121 that is connected between the antenna 2B and the output terminal of the power amplifier 131 and has a pass band including the transmission band of the band B.

With this configuration, the communication device 7 can achieve effects that are substantially the same as those achieved by the radio frequency module 5.

### Other Embodiments

Radio frequency modules and communication devices according to the embodiments of the present disclosure are described above. However, radio frequency modules and communication devices according to the present disclosure are not limited to those described in the above embodiments. Other embodiments implemented by combining components in the above embodiments, variations obtained by applying various modifications conceivable by a person skilled in the art to the above embodiments without departing from the spirit of the present disclosure, and various devices including the radio frequency modules described above are also included in the present disclosure.

For example, in the circuit configurations of the radio frequency modules according to the above embodiments, additional circuit elements and/or wires may be inserted in paths that connect the circuit elements and signal paths illustrated in the drawings.

The present invention can be widely used for communication devices, such as mobile phones, as a radio frequency module provided in a front-end unit.

What is claimed is:

1. A radio frequency module comprising:
an antenna connection terminal;
a first filter operably connected to the antenna connection terminal and has a pass band including a reception band of a first band;
a second filter operably connected to the antenna connection terminal and has a pass band including a reception band of a second frequency division duplex (FDD) band;
a low-noise amplifier circuit including a first input terminal and a second input terminal; and
a first switch, wherein
a first signal path extending from an output terminal of the first filter to the first input terminal includes the first switch;
a second signal path extending from an output terminal of the second filter to the second input terminal is free of an intervening switch; and
the reception band of the first band and a transmission band of the second FDD band at least partially overlap each other.

2. The radio frequency module according to claim 1, further comprising:
a third filter that has a pass band including a reception band of a third band; and
a second switch that includes a common terminal connected to the antenna connection terminal, a first selection terminal connected to an input terminal of the first filter and an input terminal of the third filter, and a second selection terminal connected to an input terminal of the second filter.

3. The radio frequency module according to claim 2, wherein
the first band and the third band are a band combination usable for simultaneous communication;
the second FDD band and the third band are a band combination usable for simultaneous communication;
in a first mode for simultaneously performing transmission and reception of signals in the second FDD band and reception of signals in the third band, the common terminal is connected the first selection terminal, the common terminal is connected to the second selection terminal, and the first switch is opened; and
in a second mode for simultaneously performing reception of signals in the first band and reception of signals in the third band, the common terminal is connected to the first selection terminal, and the first switch is closed.

4. The radio frequency module according to claim 2, wherein
the third filter has a pass band including the reception band of the third band and a reception band of a fourth band;
the reception band of the third band and the reception band of the fourth band at least partially overlap each other;
the first band and the third band are a band combination usable for simultaneous communication;
the second FDD band and the fourth band are a band combination usable for simultaneous communication;
in a first mode for simultaneously performing transmission and reception of signals in the second FDD band and transmission and reception of signals in the fourth band, the common terminal is connected the first selection terminal, the common terminal is connected to the second selection terminal, and the first switch is opened; and
in a second mode for simultaneously performing transmission and reception of signals in the first band and transmission and reception of signals in the third band, the common terminal is connected to the first selection terminal, and the first switch is closed.

5. The radio frequency module according to claim 4, wherein
the first band is LTE Band 3 or 5G NR n3;
the second FDD band is LTE Band 25 or 5G NR n25;
the third band is LTE Band 1 or 5G NR n1; and
the fourth band is LTE Band 66 or 5G NR n66.

6. The radio frequency module according to claim 4, wherein
the first band is LTE Band 40a or 5G NR n40a;
the second FDD band is LTE Band 30 or 5G NR n30;
the third band is LTE Band 1 or 5G NR n1; and
the fourth band is LTE Band 66 or 5G NR n66.

7. The radio frequency module according to claim 1, wherein
in a third mode for transmitting and receiving signals in the second FDD band, the first switch is opened; and
in a fourth mode for receiving signals in the first band, the first switch is closed.

8. The radio frequency module according to claim 7, wherein
the first band is LTE Band 26 or 5G NR n26; and
the second FDD band is LTE Band 8 or 5G NR n8.

9. The radio frequency module according to claim 1, wherein
the first filter has a pass band including the reception band of the first band and a reception band of a fifth band;
the reception band of the first band and the reception band of the fifth band at least partially overlap each other;
the first band and the fifth band are a band combination usable for simultaneous communication;
in a third mode for transmitting and receiving signals in the second FDD band, the first switch is opened; and
in a fifth mode for simultaneously performing reception of signals in the first band and reception of signals in the fifth band, the first switch is closed.

10. The radio frequency module according to claim 9, wherein
the first band is LTE Band 20 or 5G NR n20;
the second FDD band is LTE Band 5 or 5G NR n5; and
the fifth band is LTE Band 28 or 5G NR n28.

11. The radio frequency module according to claim 1, wherein
the low-noise amplifier circuit further includes a first output terminal,
a first amplifier transistor connected between the first input terminal and the first output terminal, and
a second amplifier transistor connected between the second input terminal and the first output terminal.

12. The radio frequency module according to claim 11, wherein the low-noise amplifier circuit further includes a third input terminal and a third amplifier transistor connected between the third input terminal and the first output terminal.

13. The radio frequency module according to claim 1, further comprising:
a first inductor arranged in the first signal path between the output terminal of the first filter and the first switch; and
a second inductor arranged in the second signal path between the output terminal of the second filter and the second input terminal.

14. The radio frequency module according to claim 1, wherein
the first switch includes
a first switch element and a second switch element that are connected in series with each other and are arranged in series between the output terminal of the first filter and the first input terminal, and
a third switch element connected between a ground and a connection point between the first switch element and the second switch element.

15. The radio frequency module according to claim 1, wherein the first switch is:
opened during a first mode of operation to prevent a transmission signal of the second FDD band from interfering with the low-noise amplifier circuit; and
closed during a second mode of operation to pass a reception signal of the first band to the low-noise amplifier circuit.

16. The radio frequency module according to claim 1, wherein the first band is one of a time division duplex (TDD) band or a supplementary uplink (SUL) band.

17. A communication device comprising:
a signal processing circuit configured to process radio frequency signals;
the radio frequency module according to claim 1, wherein the radio frequency module is configured to transfer the radio frequency signals between the signal processing circuit and a first antenna; and
a transmission module configured to transfer the radio frequency signals between the signal processing circuit and a second antenna, wherein
the transmission module includes
a power amplifier, and
a fourth filter connected between the second antenna and an output terminal of the power amplifier and having a pass band including the transmission band of the second FDD band.

18. The communication device according to claim 17, wherein the signal processing circuit is configured to:
in a first mode, output a transmission signal of the second FDD band to the power amplifier and cause the first switch to be opened; and
in a second mode, cease output of the transmission signal of the second FDD band and cause the first switch to be closed.

19. A method of operating a radio frequency module, the radio frequency module including a first filter having a reception band connected via a first switch to a first input terminal of a low-noise amplifier circuit, and a second filter connected to a second input terminal of the low-noise amplifier circuit via a path free of an intervening switch, the method comprising:
receiving, at the second input terminal, a reception signal of a second frequency division duplex (FDD) band from the second filter;
amplifying the reception signal of the second FDD band using the low-noise amplifier circuit; and
during a time when a transmission signal of the second FDD band is being transmitted, opening the first switch to disconnect the first filter from the first input terminal, wherein the reception band of the first filter at least partially overlaps a transmission band of the transmission signal of the second FDD band.

20. The method according to claim 19, further comprising:
discontinuing transmission of the transmission signal of the second FDD band;
closing the first switch to connect the first filter to the first input terminal; and
receiving, at the first input terminal, a reception signal of a first band from the first filter.
